(19) United States
(12) Patent Application Publication
(10) Pub. No.: US 2025/0236162 A1
(43) Pub. Date: Jul. 24, 2025

(54) COVER FOR A VEHICLE ROOF AND METHOD FOR PRODUCING A COVER

(71) Applicant: Webasto SE, Stockdorf (DE)

(72) Inventors: Milan MATOK, Stockdorf (DE); Alexander UNTERHOLZNER, München (DE); Michael ADAM, Stockdorf (DE); Bernhard HARNISCHFEGER, Stockdorf (DE)

(21) Appl. No.: 18/985,669

(22) Filed: Dec. 18, 2024

(30) Foreign Application Priority Data
Jan. 18, 2024 (DE) 10 2024 101 450.4

(51) Int. Cl. B60J 7/11

(52) U.S. Cl. CPC B60J 7/11

(57) ABSTRACT

A cover for a vehicle roof having a pane, a plastic border which at least partially surrounds the pane, a reinforcing profile which is arranged in the plastic border and which extends in an elongate fashion between a first end and a second end, and an end cap which is secured at the first end on the reinforcing profile. The end cap has a supporting wing which projects laterally along a first direction and which has a region of contact with the pane. In addition, a method for producing a cover is specified.

### CROSS-REFERENCE TO RELATED APPLICATION

This application claims the benefit of German Application No. 10 2024 101 450.4, filed Jan. 18, 2024, which is incorporated herein by reference in its entirety.

### TECHNICAL FIELD

The disclosure relates to a cover for a vehicle roof, in particular a cover for closing a roof opening of the vehicle roof. In addition, the disclosure relates to a method for producing a cover for a vehicle roof, in particular for producing the cover described here.

### BACKGROUND

Vehicles can be provided with an opening in the vehicle roof that is closed by means of a cover. The cover is, for example, rigidly secured or arranged in such a way that it can be moved relative to the rest of the vehicle roof. The cover can have a moulded plastic surround or foamed plastic surround. A production method for a cover of this kind is described in EP 0 355 209 B1, for example.

It is desirable to specify a cover for a vehicle roof which can be produced in a reliable and efficient way. It is furthermore desirable to specify a method for producing a cover which can be carried out in a reliable and efficient way.

### SUMMARY

According to at least one embodiment, a cover for a vehicle roof is described. The cover has a pane. The pane is a glass pane and/or a plastic pane, for example. The pane is transparent, translucent and/or tinted, for example. The cover has a plastic border. The plastic border at least partially surrounds the pane. The plastic border is formed from a PU or some other plastic, for example. The plastic border is attached to the pane by means of a foaming process and/or an injection process.

The cover has a reinforcing profile. The reinforcing profile is arranged in the plastic border. The reinforcing profile extends in an elongate fashion between a first end and a second end. The reinforcing profile has a significantly longer extent between its first end and its second end than transversely thereto. The reinforcing profile is formed from a metal, for example, e.g. from steel.

The cover has an end cap. The end cap is secured at the first end on the reinforcing profile. It is also possible for the end cap to be secured at the second end on the reinforcing profile. It is also possible for two end caps to be provided, one of the end caps being secured at the first end and another of the end caps being secured at the second end. The end cap has a supporting wing which projects laterally along a first direction. The supporting wing has a region of contact with the pane.

The plastic border of the cover also serves, for example, to provide an assembly interface for the cover. To enable additional stability, even in the case of relatively large covers, the reinforcing profile is embedded into the plastic border. During production, the reinforcing profile must be precisely positioned and held relative to the pane and, where applicable, further components. The end cap with the laterally projecting supporting wing enables this positioning, even in the case of long and possibly bent and/or curved reinforcing profiles. By virtue of the laterally projecting supporting wing, a sufficiently large and extended supporting region is obtained, thus enabling the reinforcing profile to be reliably positioned. The end cap with the laterally projecting supporting wing enables the reinforcing profile to be secured against twisting during production, thus ensuring that the position of the reinforcing profile relative to the pane is reliably maintained and twisting or some other change in position of the reinforcing profile is reliably avoided.

According to at least one embodiment, the end cap has a main body. The main body projects partially into the reinforcing profile. The supporting wing projects laterally from the main body. The main body has a part which projects into the reinforcing profile. Thus, the end cap can be secured reliably on the reinforcing profile. In addition, the end cap reliably seals the reinforcing profile at the first end and, where applicable, at the second end. This avoids a situation where plastic penetrates into the reinforcing profile during the production of the plastic border. The reinforcing profile and that part of the main body which projects into it are designed in such a way that, in the coupled state, twisting and further relative movements between the end cap and the reinforcing profile are blocked.

According to at least one embodiment, the main body has a stop in order to position the reinforcing profile and the end cap relative to one another in a predetermined way. In particular, the stop defines how far the end cap can be pushed into the reinforcing profile. Thus, the arrangement of the reinforcing profile and of the end cap relative to one another can be defined in a predetermined way by means of the stop.

According to at least one embodiment, the end cap has a further region of contact with the pane. The region of contact and the further region of contact are arranged spaced apart along the first direction. Thus, reliable support is possible along the first direction, even when the forces imposed are relatively large, and, in particular, twisting or tilting of the reinforcing profile relative to the pane during production can be avoided.

According to at least one embodiment, the end cap has a coupling region on a side facing away from the region of contact. The coupling region is coupled to a mounting plate. The mounting plate is arranged in the plastic border. The cover has the mounting plate, which is used to attach the cover to a vehicle body, for example. The mounting plate is secured on the pane by means of the plastic border. The mounting plate has elements which, for example, project out of the plastic border. In contrast thereto, the reinforcing profile is, for example, completely surrounded by the plastic border. The end cap is arranged between the mounting plate and the pane. During production, the end cap enables precise relative positioning of the reinforcing profile between the mounting plate and the pane. The reinforcing profile is thus reliably aligned in a predetermined way with respect to the mounting plate and also with respect to the pane, and unwanted relative movement is avoidable.

According to at least one embodiment, the reinforcing profile is designed as a hollow profile. The reinforcing profile may also be referred to as a hollow profile. In particular, the reinforcing profile has an interior which is free from plastic of the plastic border. The hollow profile is sealed both at the first end and at the second end, ensuring that no plastic penetrates into the interior during production. By means of the end cap, both the positioning of the hollow profile relative to the pane, and optionally to the metal plate, and also the sealing of the hollow profile to keep the interior free from plastic are achieved.

According to at least one embodiment, the reinforcing profile is curved. In particular, the reinforcing profile is curved along at least two directions. For example, the reinforcing profile is curved in two mutually perpendicular directions between the first end and the second end. The reinforcing profile is thus curved along two directions between the first end and the second end. On the one hand, the curvature of the reinforcing profile enables a central region of the reinforcing profile to be arranged spaced apart from the pane. Moreover, the central region of the reinforcing profile is spaced further away from a centre of the pane than in the case of a reinforcing profile that is not curved. It is thus possible to enlarge the viewing area through the pane since the plastic border is also shifted further to the edge of the pane.

In particular, the end cap is designed to reliably hold the reinforcing profile without additional aids during production. Thus, in particular, there is no need for any additional supporting pins or the like, which would be removed again after the production process and would thus leave behind a hole in the plastic border. It is thus possible to design the plastic border according to the exemplary embodiment to be of uninterrupted design in the region of the reinforcing profile on a plastic side facing away from the pane. In particular, no holes or the like formed by supporting pins or other production aids are formed between the reinforcing profile and the plastic side. The plastic upper side runs without interruption and completely covers the reinforcing profile. The reinforcing profile has no access to the plastic upper side or to the surroundings of the plastic border. The plastic border completely seals the reinforcing profile. The outside of the reinforcing profile is completely covered with plastic.

According to at least one embodiment, a method for producing a cover for a vehicle roof is specified. For example, a method for producing the cover described here is specified. Features, advantages and further developments of the cover thus also apply to the method and vice versa.

A reinforcing profile is supplied. An end cap is supplied. The end cap has a supporting wing which projects laterally along a first direction. The end cap is secured on the reinforcing profile. The pane is placed on the end cap. The pane is placed on in such a way that the pane is in contact with a region of contact of the supporting wing. A position and an alignment of the end cap and of the reinforcing profile relative to the pane are thereby fixed. Plastic is introduced which surrounds the reinforcing profile and the end cap to secure the reinforcing profile on the pane and to form a plastic border.

The end cap reliably positions the reinforcing profile relative to the pane during the introduction of the plastic, and therefore, in particular, no further aids, such as supporting pins or the like, are necessary. The end cap is designed to hold the reinforcing profile in such a way that it does not tip over or perform any other unwanted movements relative to the pane before or while the plastic is introduced, even in the case of a shape of the reinforcing profile with a complex curvature.

According to at least one embodiment, a part of the end cap is inserted into the reinforcing profile in order to secure the end cap on the reinforcing profile. A first end of the reinforcing profile is thereby furthermore sealed. This avoids a situation where plastic penetrates into the reinforcing profile during the introduction of the plastic.

According to at least one further embodiment, a mounting plate is supplied. The end cap is placed on the mounting plate before the pane is placed on the end cap. A position and an alignment of the end cap and of the reinforcing profile relative to the mounting plate are thereby fixed. The end cap thus makes it possible to fix the position of the pane, of the mounting plate and of the reinforcing profile relative to one another. The plastic is introduced, and therefore the plastic at least partially encloses the mounting plate. The plastic and the plastic border formed by means of the plastic thus secure the mounting plate and the reinforcing profile on the pane.

### BRIEF DESCRIPTION OF DRAWINGS

Further advantages, features and further developments will become apparent from the following examples, which are explained in conjunction with the figures. In the drawings:

FIG. 1 shows a schematic illustration of part of a vehicle according to one exemplary embodiment,

FIG. 2 shows a schematic illustration of part of a cover according to one exemplary embodiment,

FIG. 3 shows a schematic illustration of a section through a cover according to one exemplary embodiment,

FIGS. 4 and 5 each show schematic illustrations of part of the cover according to one exemplary embodiment,

FIGS. 6 to 8 each show schematic illustrations of an end cap according to one exemplary embodiment,

FIGS. 9 to 11 each show schematic illustrations of parts of the cover according to one exemplary embodiment, and

FIG. 12 shows a schematic illustration of a flow diagram of a method according to one exemplary embodiment.

### DETAILED DESCRIPTION

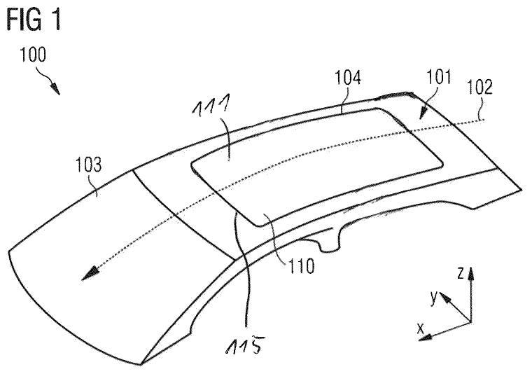

FIG. 1 shows a schematic illustration of a motor vehicle 100. The motor vehicle 100 is a passenger vehicle, for example. The motor vehicle 100 has a vehicle roof 101. The vehicle roof 101 has a roof opening 104. The roof opening 104 is closed by means of a cover 110. According to exemplary embodiments, the cover 110 is movable relative to the rest of the vehicle roof 101, e.g. in the manner of a sliding roof. According to further exemplary embodiments, the cover 110 is a so-called fixed roof element which is coupled to the vehicle body in such a way as to be immovable relative to the rest of the vehicle roof 101.

The vehicle 100 has a vehicle longitudinal direction 102. The vehicle longitudinal direction 102 may also be referred to as the X direction. The vehicle longitudinal direction refers to a normal operating position of the vehicle 100. In particular, the vehicle longitudinal direction 102 extends from the rear forwards to a windscreen 103 of the vehicle 100.

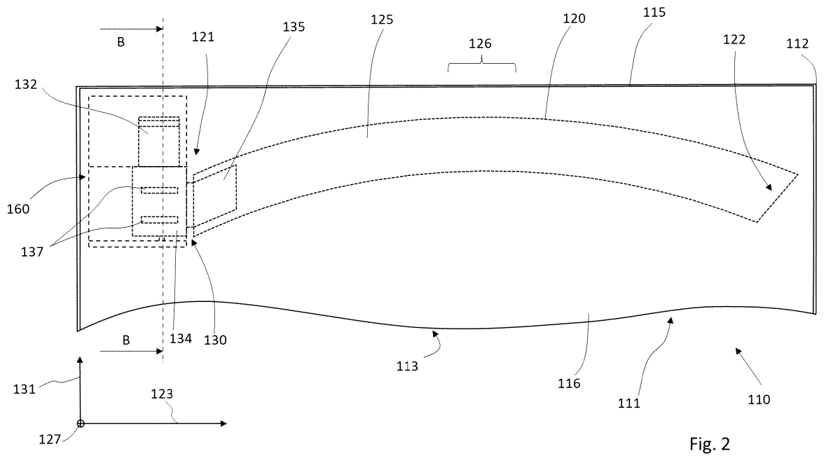

FIG. 2 shows a schematic detail view of a portion of the cover 110. FIG. 2 illustrates a plan view of the cover 110.

The cover 110 has a pane 111, e.g. a glass pane and/or a plastic pane. The pane 111 is transparent, translucent and/or tinted, for example. The pane 111 makes it possible to see through the roof opening 104, even when the cover 110 closes the roof opening 104. The pane has a pane upper side 113 facing the interior of the vehicle 100 during operation, and an opposite, further pane upper side 116, which faces outwards during operation, as can also be seen from FIG. 3.

The cover 110 has a plastic border 112. The plastic border 112 partially or completely surrounds the pane 111 in a rim region. For example, all four sides in the XY plane of the pane 111 are covered by the plastic border 112 on the pane upper side 113. However, a central region and, in particular, the majority of the pane 111 are free from plastic and thus it is made possible to look through the pane 111.

The plastic border 112 is, in particular, formed from a foamed and/or injected plastic. The plastic is a polyurethane or comprises a polyurethane, for example. Other plastics may also be used. The plastic border 112 is produced in a foaming process or by injection moulding, for example.

The pane upper side 113 is, in particular, a main surface of the pane 111, which faces the vehicle interior in the state ready for operation. Opposite this is the second pane upper side 116, which faces outwards in the operational state. Lateral surfaces connect the two main surfaces transversely to the main surfaces. The two main surfaces are of significantly larger design than the lateral surfaces.

The cover 110 has a reinforcing profile 120. The reinforcing profile 120 is, in particular, formed from a metal or comprises metal. The reinforcing profile is a hollow profile and can be referred to as a rolled profile. The reinforcing profile 120 is arranged at least on one of the longitudinal sides of the cover 110, e.g. at a front edge 115 of the cover 110 facing the windscreen 103. The front edge 115 runs substantially along the transverse direction Y and transversely to the vehicle longitudinal direction 102.

According to exemplary embodiments, two or more reinforcing profiles 120 are provided, each being assigned to lateral edges of the cover 110. For example, the reinforcing profile 120 is arranged on the pane upper side 113.

The reinforcing profile 120 has a first end 121 and a second end 122. The reinforcing profile 120 extends between the two ends 121, 122 in a manner extended in elongate fashion along a main direction of extent 123. In the exemplary embodiment shown, the reinforcing profile 120 is not of rectilinear design along the main direction of extent 123 but has a curvature 125. In particular, the reinforcing profile 120 is curved in such a way that, in a central region 126, which is at the same distance from the first end 121 as from the second end 122 in the main direction of extent 123, it is arranged closer to the front edge 115 than at the two ends 121, 122. Moreover, the curvature 125 is designed in such a way that the reinforcing profile 120 is further away from the pane upper side 113 in a spacing direction 127 in the central region 126 than at the two ends 121, 122. The spacing direction 127 is aligned perpendicularly to the main direction of extent 123 and corresponds, for example, to a perpendicular to the pane upper side 113.

The curvature 125 of the reinforcing profile 120 is designed in such a way that a viewing area through the pane 111 is as large as possible and is not impaired in an unwanted way by the reinforcing profile 120. By virtue of the fact that the reinforcing profile 120 is curved outwards in the central region 126 and faces the front edge 115, additional viewing area of the pane 111 is exposed.

The reinforcing profile 120 serves to stabilize and reinforce the pane 111 and/or the plastic border 112. In particular, the reinforcing profile 120 is more stable with respect to bending and other deformations than the pane 111 and/or the plastic border 112 alone.

According to FIG. 2, an end cap 130 is provided at the first end 121 of the reinforcing profile 120. No end cap is illustrated at the second end 122 in FIG. 2. However, it is possible for the end cap 130 to be arranged at the second end 122 as well, the associated end cap 130 thus being provided at both ends 121, 122. In particular, the end caps 130 are of corresponding design to one another, being of identical construction, and may be mirror images of one another.

The end cap 130 serves to hold and align the reinforcing profile 120 relative to the cover 110 and to a mounting plate 160, in particular during the production of the plastic border 112 in a mould.

The mounting plate 160 is, for example, an additional element for reinforcing the cover 110, and, alternatively or in addition, offers assembly interfaces for securing the cover 110 on the rest of the vehicle roof 101.

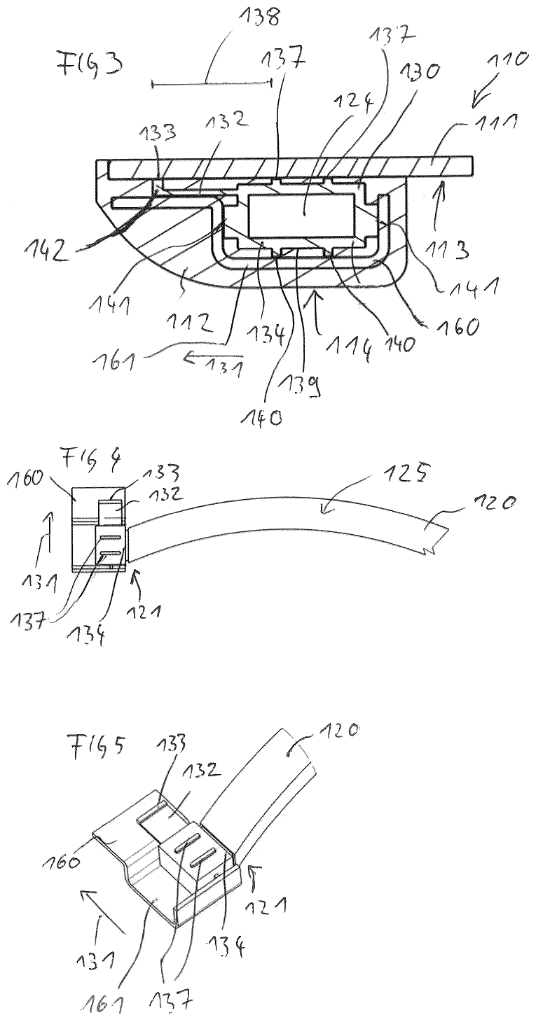

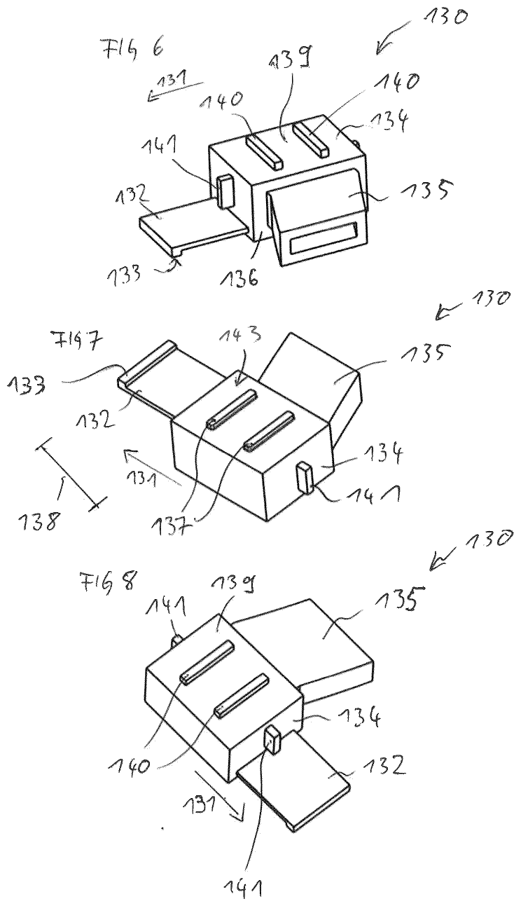

The end cap 130 is formed from a plastic and is secured on the reinforcing profile 120. As is apparent, in particular, also from FIGS. 3 to 8, of which FIG. 3 shows a sectional view along the line BB in FIG. 2, the end cap 130 has a main body 134 and a supporting wing 132. The supporting wing 132 projects from the main body 134 along a first direction 131. For example, the supporting wing 132 projects by a few centimetres, in particular between 1 cm and 10 cm, along the first direction 131. The supporting wing 132 has a length of between 1 cm and 10 cm along the first direction 131, for example. Other lengths are also possible.

The end cap 130 has a region of contact 133, which is formed on the supporting wing 132. In particular, the region of contact 133 is formed on a free end 142 of the supporting wing 132. The free end 142 faces away from the main body 134 along the first direction 131.

The region of contact 133 serves to support the supporting wing 132 on the pane upper side 113 of the pane 111.

A further region of contact 137 or further regions of contact 137, which likewise serve to support the end cap 130 on the pane upper side 113, is/are arranged on the main body 134. The region of contact 133 and the further regions of contact 137 are of rib-shaped design, for example.

The region of contact 133 and the further region of contact 137 which is closest along the first direction 131 have a spacing 138 along the first direction 131. The size of this spacing is chosen so that twisting of the end cap 130 can be reliably avoided by means of the supporting wing 132 and the region of contact 133 arranged there.

The end cap 130 has a coupling region 140 or a plurality of coupling regions 140, which are designed to be in contact with the mounting plate 160. In particular, the coupling regions 140 are in contact with a set-back region 161 of the mounting plate 160. The main body 134 is arranged in the set-back region 161. The coupling regions 140 are arranged on the main body 134. The size of the main body 134 and the extent of the supporting wing 132, of the region of contact 133, of the further region of contact 137, of the coupling region 140 and of further coupling regions 141 are matched to the dimensioning of the mounting plate 160 and, in particular, of the set-back region 161. Moreover, a desired spacing between the mounting plate 160 and the pane upper side 113 can be achieved by means of the configuration of the end cap 130.

The further coupling regions 141 serve, in particular, for the positioning of the main body in the set-back region 161 along the first direction 131. The coupling regions 140 serve, for example, for the alignment of the pane 111 and of the mounting plate 160 as well as of the reinforcing profile 120 relative to one another transversely to the first direction 131.

For positioning of the end cap 130 and of the reinforcing profile 120 relative to one another in a manner defined in a predetermined way, the end cap 130 has a part 135 which is arranged in the reinforcing profile 120. Part 135 of the end cap 130 can be inserted into the reinforcing profile 120 until the reinforcing profile 120 strikes against a stop 136 of the end cap 130 at the first end 121. Thus, the relative alignment of the end cap 130 and of the reinforcing profile 120 can be predetermined in a defined way.

The mounting of the end cap 130 on the reinforcing profile 120 and the leaktight sealing at the part 135 furthermore ensures that no plastic gets into an interior 124 of the reinforcing profile 120 during production. The interior 124, which is surrounded by the reinforcing profile 120, is free from plastic and, for example, is filled with air.

FIGS. 6 to 8 show the end cap 130 from various directions of view. The further regions of contact 137 are arranged on a side 143 which faces the pane 111 during operation. In the exemplary embodiment illustrated, two rod-shaped further regions of contact 137 are illustrated. The further regions of contact 137 may also have any other suitable shape, being circular for example. It is also possible for more than two or just a single further region of contact 137 to be formed.

The supporting wing 132 is arranged laterally on the main body 134 and, in particular, is arranged closer to the facing side 143 than to an opposite side 139 that faces away. Moreover, the further coupling region 141 is arranged at the side of the main body 134. The supporting wing 132 projects further than the further coupling region 141 along the first direction 131. It is thus possible to arrange the supporting wing 132 between the pane upper side 113 and a part of the mounting plate 160 arranged close to the pane upper side 113. The set-back region 161 can therefore be of smaller design and it is thus possible to save installation space overall.

The further coupling regions 141 are arranged on that side 139 of the main body 134 which faces away from the pane upper side 113 during operation. In the exemplary embodiment illustrated, two rod-shaped coupling regions 140 are illustrated. The coupling regions 140 can have other shapes, being circular for example. It is also possible to provide more than two coupling regions 140 or just a single coupling region 140.

The main body 134 with the coupling regions 140 and the further coupling regions 141 is designed in such a way that it can be arranged in the set-back region 161. By means of the contact between the end cap 130 and the mounting plate 160 in the coupling regions 140 and the further coupling regions 141, it is possible reliably to predetermine a relative position between the end cap 130 and the mounting plate 160.

The region of contact 133 and the further regions of contact 137 then furthermore represent a contact possibility for the pane 111, and therefore the pane 111 too can be reliably positioned relative to the end cap 130. On account of the known alignment of the end cap 130 and of the reinforcing profile 120 relative to one another, the reinforcing profile 120 is thus also reliably positioned in a predetermined way with respect to the mounting plate 160 and to the pane 111. Despite the curvature 125, the reinforcing profile 120 is reliably held and secured against unwanted twisting relative to the pane 111 by means of the end cap 130, in particular by virtue of the projecting supporting wing 132, which is clamped between the pane upper side 113 and the mounting plate 160.

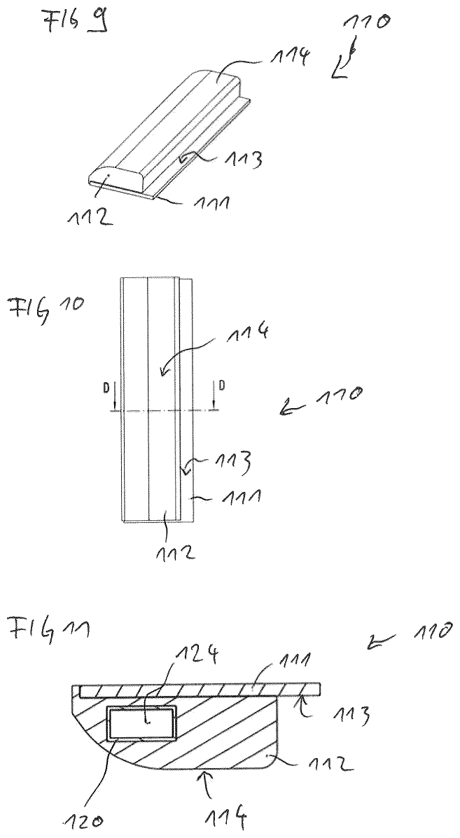

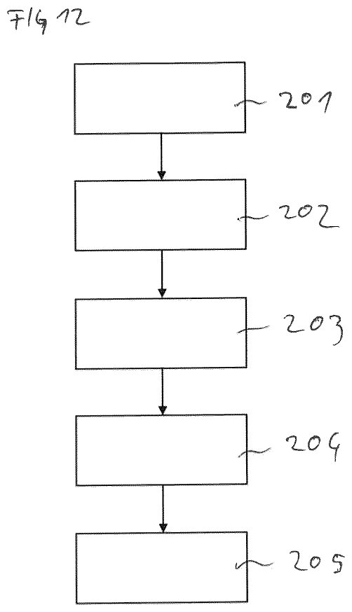

FIGS. 9 to 11 show detail views of the plastic border 112 on the pane 111. By virtue of the reliable support of the reinforcing profile 120 by means of the end cap 130, it is possible to form the plastic border 112 without interruption, at least in the region of the reinforcing profile 120. A plastic upper side 114 of the plastic border 112, which faces away from the pane upper side 113, is of continuous and uninterrupted design. The end cap 130 holds the reinforcing profile 120 in a sufficiently reliable way despite the curvature 125, and there is therefore no need, in particular, for any additional holding elements. These additional holding elements would leave traces on the plastic upper side 114, e.g. interruptions that would extend from the plastic upper side 114 to the reinforcing profile 120. The reinforcing profile 120 is arranged completely in the plastic border 112 and completely covered with plastic.

FIG. 12 shows a schematic flow diagram relating to the production of the cover 110.

In a step 201, the reinforcing profile 120 is supplied. In particular, the reinforcing profile 120 is supplied with the curvature 125.

In a step 202, the end cap 130 is supplied.

In a step 203, the end cap is secured on the reinforcing profile 120. For example, part 135 of the end cap is inserted into the reinforcing profile 120 until the reinforcing profile 120 is resting against the stop 136.

In a step 204, the pane 111 is placed on the end cap 130. For example, the end cap 130 has been placed in the mounting plate 160 beforehand. In particular, the end cap 130 has been placed by means of the main body 134 in the set-back region 161, and the supporting wing 132 projects beyond the set-back region 161. By virtue of the special configuration of the end cap 130, the end cap 130 is positioned in a predetermined way along all three spatial directions relative to the mounting plate 160. Thus, the reinforcing profile 120 too is positioned in a predetermined way relative to the mounting plate 160. The pane 111 is then placed on the end cap 130. The pane 111, the reinforcing profile 120 and the mounting plate 160 are thus positioned in a predetermined way relative to one another. By virtue of the special configuration of the end cap 130 and, in particular, by virtue of the projecting supporting wing 132, a change in the relative position due, for example, to twisting caused by the curvature 125 is furthermore reliably avoided.

For example, the mounting plate 160, the reinforcing profile 120 with the end cap 130 and the pane 111 are arranged in a mould. In a step 205, plastic is introduced into the mould, with the result that the plastic surrounds the reinforcing profile and the end cap 130, in particular completely, with the exception of the regions of contact with the pane 111 and the mounting plate 160. The plastic serves to secure the reinforcing profile 120 and, where applicable, the mounting plate 160 on the pane 111. Moreover, the plastic forms the plastic border 112.

The end cap 130 serves to seal the interior 124 of the reinforcing profile 120 during the introduction of the plastic and to secure the reinforcing profile 120 against twisting. The end cap 130 positions the reinforcing profile 120 in all three spatial directions relative to the mounting plate 160 and the pane 111. Thus, overall, it is possible to obtain a cover 110 which allows a desirably large viewing area while being reliably reinforced by means of the reinforcing profile 120 and having the uniform and uninterrupted plastic upper side 114 on the plastic border 112.

### REFERENCE SIGNS

100 vehicle
101 vehicle roof
102 vehicle longitudinal direction
103 windscreen
104 roof opening
110 cover
111 pane
112 plastic border
113 pane upper side
114 plastic upper side
115 front edge
116 further pane upper side
120 reinforcing profile
121 first end
122 second end
123 main direction of extent
124 interior
125 curvature
126 central region
127 spacing direction
130 end cap
131 first direction
132 supporting wing
133 region of contact
134 main body
135 part
136 stop
137 further region of contact
138 spacing between regions of contact
139 side facing away
140 coupling region
141 further coupling region
142 free end
143 facing side
160 mounting plate
161 set-back region
201-205 method steps
X longitudinal direction
Y transverse direction
Z vertical direction

1. Cover for a vehicle roof, comprising:
a pane,
a plastic border, which at least partially surrounds the pane,
a reinforcing profile, which is arranged in the plastic border and which extends in an elongate fashion between a first end and a second end,
an end cap, which is secured at the first end on the reinforcing profile,
wherein the end cap has a supporting wing which projects laterally along a first direction and which has a region of contact with the pane.

2. Cover according to claim 1, on which the end cap has a main body which projects partially into the reinforcing profile.

3. Cover according to claim 1, on which the end cap has a stop in order to position the reinforcing profile and the end cap relative to one another in a predetermined way.

4. Cover according to claim 1, on which the end cap has a further region of contact with the pane, wherein the region of contact and the further region of contact are arranged spaced apart along the first direction.

5. Cover according to claim 4, on which the end cap has a coupling region on a side facing away from the region of contact, which coupling region is coupled to a mounting plate, wherein the mounting plate is arranged in the plastic border.

6. Cover according to claim 1, on which the reinforcing profile is designed as a hollow profile.

7. Cover according to claim 6, on which an interior of the hollow profile is free from plastic of the plastic border.

8. Cover according to claim 1, wherein the reinforcing profile is curved.

9. Cover according to claim 1, having a second end cap which is secured at the second end on the reinforcing profile, and is of corresponding design to the first end cap.

10. Cover according to claim 1, on which the plastic border is of uninterrupted design in the region of the reinforcing profile on a plastic side facing away from the pane.

11. Method for producing a cover for a vehicle roof, comprising:
supplying a reinforcing profile,
supplying an end cap which has a supporting wing that projects laterally along a first direction,
securing the end cap on the reinforcing profile,
placing a pane on the end cap, with the result that the pane is in contact with a region of contact of the supporting wing, and thereby fixing a position and an alignment of the end cap and of the reinforcing profile relative to the pane,
introducing plastic which surrounds the reinforcing profile and the end cap to secure the reinforcing profile on the pane and to form a plastic border.

12. Method according to claim 11, comprising:
inserting a part of the end cap into the reinforcing profile, and thereby
sealing a first end of the reinforcing profile.

13. Method according to claim 11, comprising:
supplying a mounting plate,
placing the end cap on the mounting plate before the placement of the pane, and thereby fixing a position and an alignment of the end cap and of the reinforcing profile relative to the mounting plate,
introducing the plastic, with the result that the plastic at least partially encloses the mounting plate.
